(19) United States
(12) Patent Application Publication
(10) Pub. No.: US 2009/0295616 A1
(43) Pub. Date: Dec. 3, 2009

(54) HANDS-FREE DEVICE FOR REMOTE CONTROL

(76) Inventor: Charles Martin, Lantin (BE)

Correspondence Address: KNOBBE MARTENS OLSON & BEAR LLP, 2040 MAIN STREET, FOURTEENTH FLOOR, IRVINE, CA, 92614, US

(21) Appl. No.: 12/470,388

(22) Filed: May 21, 2009

Related U.S. Application Data
(60) Provisional application No. 61/055,876, filed on May 23, 2008.

(30) Foreign Application Priority Data
May 23, 2008 (EP) EPO8447027.7

(51) Int. Cl. H04L 17/02

(52) U.S. Cl. 341/176

(57) ABSTRACT

An electronic remote-control system is disclosed. The system includes a control device, having a finger attachment, at least one switch, and means for wirelessly communicating with a remote control. The system also includes a wireless remote control, having means for wirelessly communicating with the control device and with an electronic receiver device, and an electronic receiver device, having means for wirelessly communicating with the remote control.

### CROSS REFERENCE TO RELATED APPLICATIONS

This application claims priority to U.S. Provisional Application No. 61/055,876, filed May 23, 2008, and European Patent Application No. EP08447027.7, filed May 23, 2008, which are hereby incorporated by reference, in their entirety.

### BACKGROUND

1. Field of the Invention

The field relates to a device of the type “hands-free” kit that allows to activate a wireless remote control, possibly bidirectional, without holding this remote control in the hand.

The application field relates to remotely controlled electronic equipment, and in particular that of animal training by electronic means.

2. Description of the Related Technology

In the context of animal training, control systems for training or confining are known that use, for one thing, a wireless remote control and for another a receiver in the form of a collar worn by the animal, in particular a dog. The purpose of these systems is to remotely transmit stimuli aimed at inducing specific behavior in the animal (electrical, audio, olfactory, etc. stimulation). See for example: U.S. Pat. No. 6,019,066, JP-A-2000/262174, US-A-2007/191913, U.S. Pat. No. 6,549,133 B2, US-A-2007/204803, U.S. Pat. No. 5,815,077, etc.

In this context, it is often useful to be able to control one's dog whilst at the same time carrying out actions elsewhere that require both hands. Moreover, holding a remote control in one's hand for a certain period of time, for example whilst going for a walk, may prove uncomfortable in the long term, even if today's remote controls are small and light.

### SUMMARY OF CERTAIN INVENTIVE ASPECTS

Some aspects provide a solution that allows to overcome the drawbacks of the state of the art.

In particular, some aspects provide a device that allows to operate a wireless remote control without holding this remote control in the hand.

Some aspects provide a hands-free kit for remotely training animals.

Some aspects provide a remotely controlled training device that allows to manage each animal individually and specifically, whilst avoiding interference between various devices.

One aspect is a remotely controlled electronic system comprising:

a “hands-free” control device in the form of an element called a ring, equipped with a means for attaching it to a finger, with at least one switch as well as with a means of wireless telecommunication with a remote control;

a wireless remote control equipped with a means of wireless telecommunication for one thing with said ring that can be attached to a finger and for another with an electronic receiver device;

an electronic receiver device equipped with a means of wireless telecommunication with said remote control.

Moreover, some embodiments comprise combinations of one or several of the following features:

the attachment means to the finger comprises an elastic strap or piece of fabric, a Velcro® strap or a system comprising two ergonomic clips;

said ring comprises a pair of switches corresponding to two separate commands that can be programmed by the remote control;

a pair of corresponding switches also belong to the remote control;

the means of wireless telecommunication is a means of telecommunication by radio waves with a range of at least 10 meters, preferably with ZigBee or Bluetooth® technology, by infrared or by ultrasound; this means of wireless telecommunication may be unidirectional bidirectional;

the remote control may control several receiver devices and may communicate with several rings;

the system comprises a means for synchronizing each ring bi-uniquely with its corresponding receiver device;

a unique identification code is associated with each ring and stored in its memory;

the commands associated with the two switches of the pair serve to control two separate receiver devices;

the electronic receiver device belongs to a piece of equipment or collar for training the animal;

the electronic receiver device belongs to a radio-controlled device.

### BRIEF DESCRIPTION OF THE FIGURES

FIG. 1 schematically shows the hands-free device for remotely training an animal as in the present invention, comprising a ring, a remote control and a training collar.

FIG. 2 is the chart showing the principle of the above-mentioned ring.

FIG. 3 is the chart showing the principle of the above-mentioned remote control.

FIG. 4 is the chart showing the principle of the above-mentioned collar.

### DETAILED DESCRIPTION OF CERTAIN INVENTIVE ASPECTS

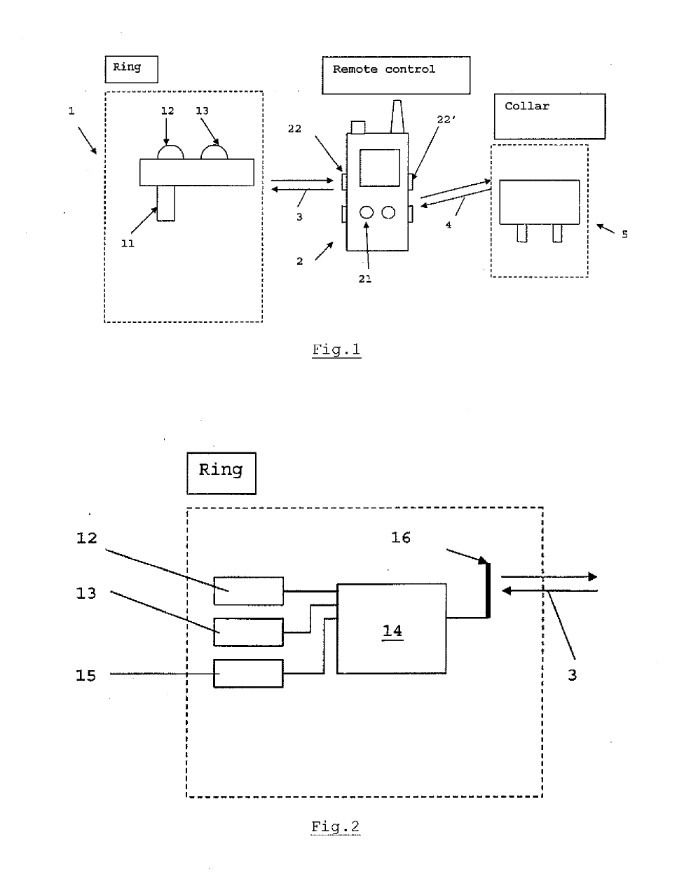

Some embodiments include a ring comprising, for example, two switches that communicate with the actual remote control. This ring is adapted to be attached to a finger of a hand, for instance the index finger, the thumb then being used to operate the switches. Any type of switch known to those skilled in the art may be used (for example lever, toggle, slide, push-button, dial, touch-sensitive, etc., switch). More particularly, one embodiment comprises a “hands-free” kit for training an animal comprising a ring 1 to be placed on a finger of a hand, a remote control 2 and a training collar 5 (see FIG. 1). The presence of two switches 12, 13 is advantageous when training animals since it allows either to reward the behavior or movement that the dog has just performed (e.g. sound signal) or to punish it (e.g. punitive electric shock).

The ring 1, marked as “Ring” in FIG. 1, is attached to the finger by a suitable attachment device 11 such as a piece of elastic fabric, a Velcro® strap or even by two ergonomic clips in such a way that the ring 1 may adapt to various sizes of finger.

The ring 1 comprises a microcontroller 14 with an RF transmitter/receiver module (not shown) and connected to both above-mentioned switches 12, 13, to a battery 15 and to an aerial 16 on the radio transmitter (see FIG. 2).

An identification code (ID CODE) is stored in an EEPROM (not shown) linked to the microcontroller 14 and is unique to each ring 1. With each command transmitted, the ID CODE will be stated at the start of the sequence, which will allows to differentiate between commands sent by different rings that are close to each other.

The remote control 2 which serves to process the information from the ring 1 (bidirectional communication 3 at a short distance, i.e. a few meters) and to send the command to the collar 5 (bidirectional communication 4 at a long distance, i.e. a few hundred meters or even several kilometers).

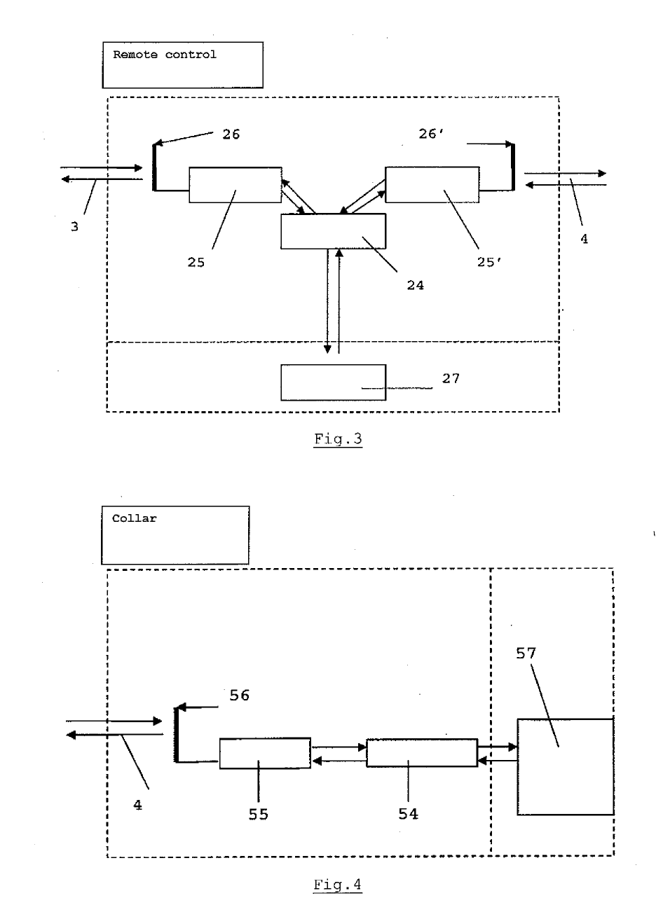

The remote control 2 comprises a microcontroller 24 with a bidirectional link on the one hand to a user interface 27 and on the other to an RF transmitter/receiver module 25 associated to an aerial 26 for the bidirectional communication 3 with the ring 1 and an RF transmitter/receiver module 25′ associated to an aerial 26′ for the bidirectional communication 4 with the collar 5 (see FIG. 3).

Moreover, the remote control 2 may operate on its own, without the ring 1. Therefore, to this end, pairs of switches 22,22′, etc. are also fitted to the remote control 2 box (see FIG. 1).

In addition, the collar 5, fitted with traditional training devices, receives the information from the remote control 2. It comprises a microcontroller 54 linked on the one hand to an RF transmitter/receiver module 55 connected to an aerial 56 for the bidirectional communication 4 with the remote control 2 and on the other to a training system 57 such as for example a high-voltage electric pulse generator.

The transmitters/receivers used will preferably be integrated (shared electronics and boxes, transceivers) and will preferably use the ZigBee protocol (protocol IEEE 802.15.4).

If the remote control used can control N collars (N being a positive integer), N rings may possibly be linked to it. Now each ring will control one single collar by means of the remote control 2. The synchronization of the ring m (1≦m≦N) with the collar m will occur during a specific programming sequence.

The synchronization of the ring with a collar may then be achieved in the following manner: pressing the “hands-free programming” switch 21 of the remote control for a long time puts it into a specific programming mode. One then presses one of the two switches 22 on the remote control 2 for dog A, for example. Lastly, one presses one of the two switches 12, 13 on the corresponding ring 1. This then sends its (unique) ID CODE to the remote control 2. The remote control 2 associates this ID CODE with dog A and stores the information in its memory.

If a second ring should be synchronized, the procedure is started again but using the switches 22′ on the remote control 2 for dog B, for example. Since each command sequence comprises the ID CODE of the transmitting ring, the remote control can pass the command from the ring on to the intended collar. Moreover, if several users who are close to each other are using the same system, there is no risk of interference.

The two switches 12, 13 on the ring 1 generally correspond to two separate commands for the same collar 5 which are preprogrammed by the remote control 2.

However, the invention is not restricted to this particular configuration and other configurations known to those skilled in the art may also be used such as, for example, a configuration where the two switches 12, 13 of the above-mentioned pair control two different collars A and B, respectively.

The “collar” 5 provides the training system between the animal to be trained and the remote control 2. But, it may be any other receiver system controlled by radio waves such as the receiver of a radio-controlled device.

While the above detailed description has shown, described, and pointed out novel features as applied to various embodiments, it will be understood that various omissions, substitutions, and changes in the form and details of the devices or processes illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. An electronic remote-control system, comprising:
a control device comprising:
a finger attachment,
at least one switch, and
means for wirelessly communicating with a remote control;
a wireless remote control comprising means for wirelessly communicating with the control device and with an electronic receiver device; and
an electronic receiver device comprising means for wirelessly communicating with the remote control.

2. The system as in claim 1, wherein the finger attachment comprises at least one of an elastic strap, a piece of fabric, a Velcro® strap, and a system comprising two ergonomic clips.

3. The system as in claim 1, wherein the control device comprises a pair of switches, each corresponding to one of two separate commands programmable by the remote control.

4. The system as in claim 3, wherein the remote control comprises a pair of switches corresponding to the switches of the control device.

5. The system as in claim 1, wherein each of the means for wirelessly communicating has a range of at least 10 meters.

6. The system as in claim 1, wherein the remote control is configured to control a plurality of receiver devices and to communicate with a plurality of control devices.

7. The system as in claim 6, further comprising means for synchronizing each control device individually.

8. The system as in claim 6, wherein a unique identification code is associated with each control device.

9. The system as in claim 3, wherein the commands control two different receiver devices.

10. The system as in claim 1, wherein the electronic receiver device is part of a piece of equipment for training an animal.

11. The system as in claim 1, wherein the electronic receiver device is part of a radio-controlled device.

12. The system as in claim 1, wherein each of the means for wirelessly communicating are bidirectional.

13. The system as in claim 1, wherein the control device comprises a ring.

14. The system as in claim 1, wherein each of the means for wirelessly communicating is configured to use at least one of ZigBee, Bluetooth®, infrared, and ultrasound signaling.

15. The system as in claim 1, wherein the electronic receiver device is part of a collar for training an animal.
